(19) United States
(12) Patent Application Publication
(10) Pub. No.: US 2016/0000034 A1
(43) Pub. Date: Jan. 7, 2016

(54) Climate controlled pet bed and method for providing comfortable conditions for a pet

(71) Applicant: Irfan Yousuf, Helena, AL (US)

(72) Inventor: Irfan Yousuf, Helena, AL (US)

(21) Appl. No.: 14/322,845

(22) Filed: Jul. 2, 2014

(51) Int. Cl. A01K 1/035; A47C 21/04; A47C 27/00

(52) U.S. Cl. CPC A01K 1/0353; A47C 27/007; A47C 21/046

(57) ABSTRACT

A pet bed and method for providing comfortable conditions for a pet comprising a top surface, a bottom surface, a sidewall and a plurality of apertures running through the bed at an angle perpendicular to the top and bottom surfaces. The pet bed is placed on top of a floor air vent in a living space whereby the warm or cool air of a heat and cooling ventilation system flows through the apertures and warms or cools a pet while allowing the pet to rest. A removable cover that is air permeable is installed on the pet bed. A pet attractant can be inserted into one or more of the apertures for luring the pet to the bed.

### PRIORITY

This application claims priority of Provisional Patent Application No. 61/965,014.

### FIELD OF THE INVENTION

The present invention relates to a pet bed and a method for creating a climate controlled environment for a pet.

### BACKGROUND OF THE INVENTION

While there are many pet beds in existence, none of the beds provide a truly comfortable bed that can cool or heat an animal in an economic fashion with minimal maintenance and operating procedure required. Though there are some pet beds or pet carriers that provide heating and/or cooling means to a pet, they are either complicated, economically infeasible, bulky, have numerous moving parts and are generally uncomfortable. Specifically, U.S. Pat. No. 8,291,866 B2 to Cauchy et al., discloses a pet carrier that has ability to heat or cool a pet. The Cauchey patent discloses the use of heat sinks, fans, and electrical systems to accomplish its goal of providing climate control for a pet. However, it is bulky, costly to produce, uncomfortable and confining to a pet.

When given a choice, pets tend to prefer and seek out comfortable resting areas which include the surface they rest on and the ambient temperature surrounding them. Often times in a home, pets prefer temperatures that are different than that of their owners. In warmer temperatures, pets prefer cooler surrounding temperatures than humans in a living space because a pet's fur keeps them warmer. In colder temperatures, it is often the case that as hot air rises and cold air sinks, the temperature of the airspace closest to the floor can differ a great degree as compared with that portion higher in the air column. Given that pets generally occupy that space closest to the floor they can become cold while their owner may be comfortable with the surrounding temperatures.

What is needed in the art is a pet bed and method for providing temperature control for a pet that is comfortable, un-confining, easily movable to different locations in a living space, simple in design, simple to operate and economical to produce.

### SUMMARY

The present invention is a pet bed and method to provide a pet with comfortable and climate-controlled conditions. The pet bed has an upper surface and a lower surface with the upper surface substantially parallel to the bottom surface. A plurality of apertures are formed through the pet bed in a direction perpendicular to the upper and bottom surfaces by cutting them out of the foam. These apertures are formed for the purpose of allowing air to flow through them and into contact with a pet's body that is resting on the upper surface. In use, the pet bed is placed over an air vent located on the floor of a living space which allows the air to come into contact with the pet bed and the pet, thus heating or cooling both the pet and the pet bed. The use of the pet bed on a pre-existing air vent takes advantage of the inevitable heating and cooling costs in a living space as its use is incidental to the use of a HVAC system in a living space.

The apertures can be formed in an array across the pet bed, but are generally formed in a location that corresponds to the area occupied of a typical air vent found in a living space. The foam must be of sufficient rigidity to prevent a pet's weight on the upper surface to collapse the apertures which would constrict air flow. The foam could be a number of different types including, but not limited to, polyurethane foam, viscoelastic polyurethane foam, ethylene-vinyl acetate foam, latex foam, and poly-vinyl chloride foam. These and other similar foam materials allow the pet bed to be comfortable while also providing for apertures that will not collapse. In addition, the pet bed could be formed of plastic, carbon fiber, fiberglass or wood.

The apertures should be of sufficient of diameter to allow appropriate air flow but not large enough to cause discomfort or allow a pet's foot to get stuck. In one embodiment, the pet bed's upper surface can have a slight depression in the central region of the pet bed that allows a pet to be nested or cradled by the pet bed. An air-flow permeable removable cover can also be used with the pet bed so as to protect the pet bed from being soiled over time by a pet. The cover can be made of various types of cloth.

The pet bed can also be used in conjunction with a pet attractant such as Nepeta Cataria, otherwise known as catnip. This can be achieved by placing the attractant in a small bag and inserting it into one or more of the apertures. In addition, the pet attractant can be placed in capsule form and inserted into one or more of the apertures in the pet bed.

### BRIEF DESCRIPTION OF THE DRAWINGS

The present invention can be best understood in connection with the accompanying drawings. It is noted that the invention is not limited to the precise embodiments shown in the drawings, in which:

FIG. 1 is a perspective view of the pet bed.

FIG. 2 is a perspective view of the pet bed with the removable cover.

FIG. 3 is a bottom plan view of the pet bed.

FIG. 4 is a perspective view of the pet bed being placed on top of an air vent.

FIG. 5 is side elevation of the pet bed.

FIG. 6 is a perspective view of the pet bed showing installation of pet attractant.

### DETAILED DESCRIPTION OF THE PREFERRED EMBODIMENTS

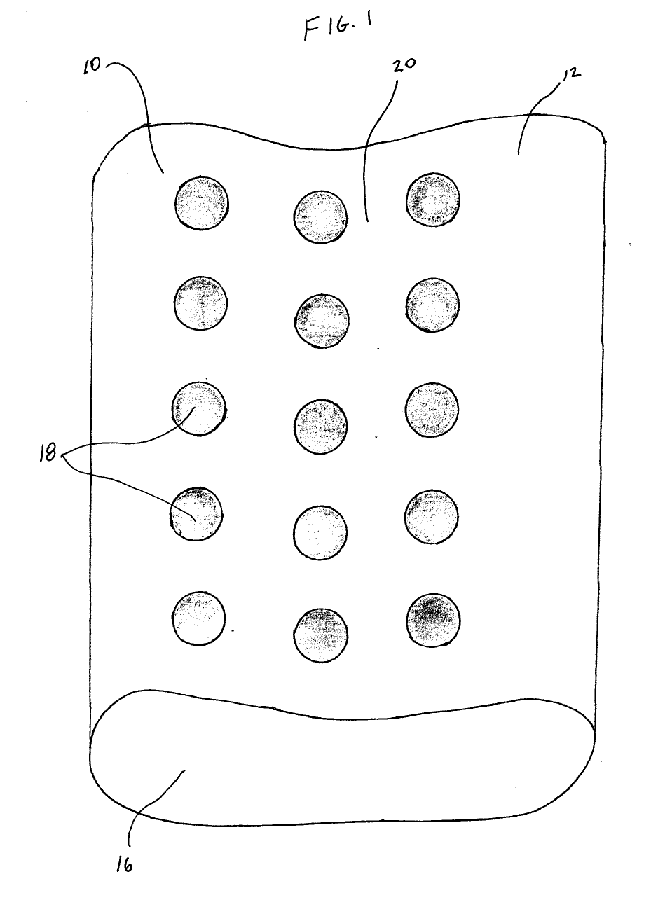

FIG. 1 shows the pet bed 10 including a top surface 12, a sidewall 14, apertures 18 and a central region depression 20. The pet bed 10 can be made of many different materials such as plastic, carbon fiber, fiberglass, wood, or foam. With regards to foam, the pet bed 10 could be made from, but not limited to, polyurethane foam, viscoelastic polyurethane foam, ethylene-vinyl acetate foam, latex foam, and poly-vinyl chloride foam. The apertures 18 are formed by cutting through the material with a blade, punch or rotational cutting tool. Alternatively, the pet bed 10 and apertures 18 could be formed by using a mold. The apertures 18 in a preferred embodiment would have a diameter of 0.5 to 1.0 inch. Larger apertures 18 could cause pet discomfort or allow a pet foot to become lodged therein. The foam or any other material used must be rigid enough to support a pet's weight without collapsing the apertures 18 and thereby blocking air flow.

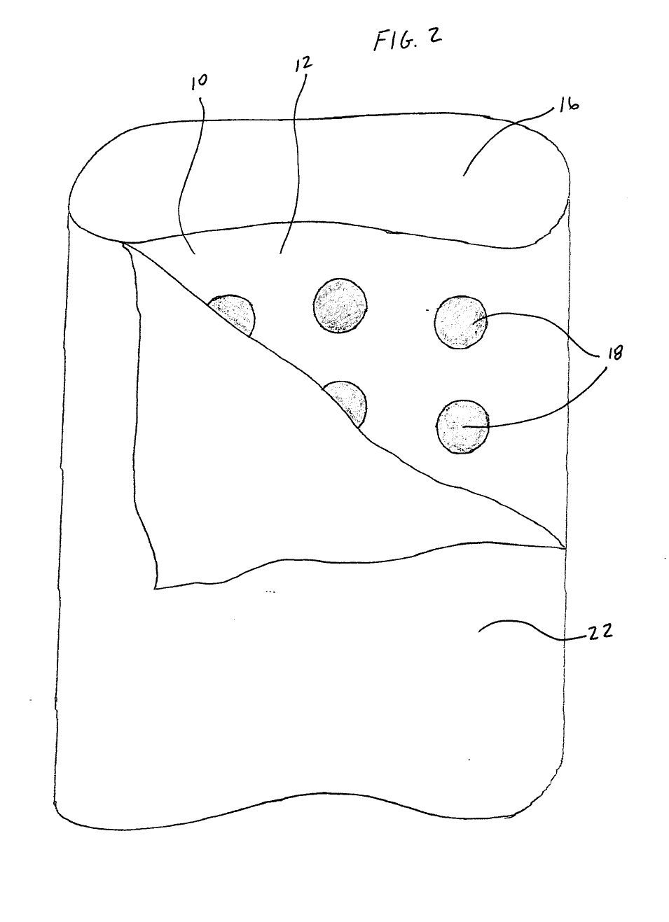

FIG. 2 shows the pet bed 10 with a porous removable cover 22 installed. The removable cover is made of a permeable material that will allow air to cross through. In one embodiment the removable cover 22 is formed of cloth.

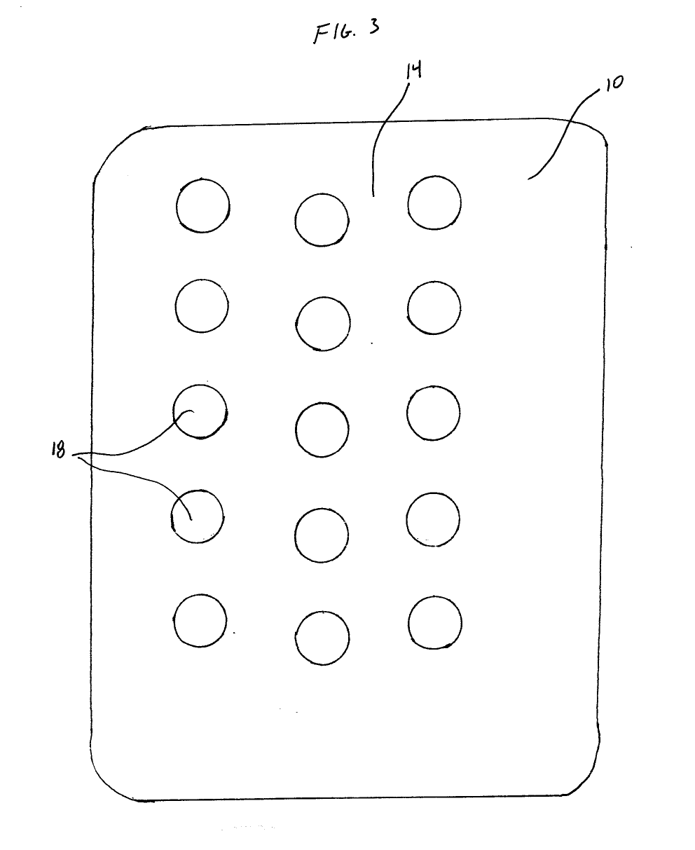

FIG. 3 shows the bottom surface 12 of the pet bed 10 as well as the apertures 18.

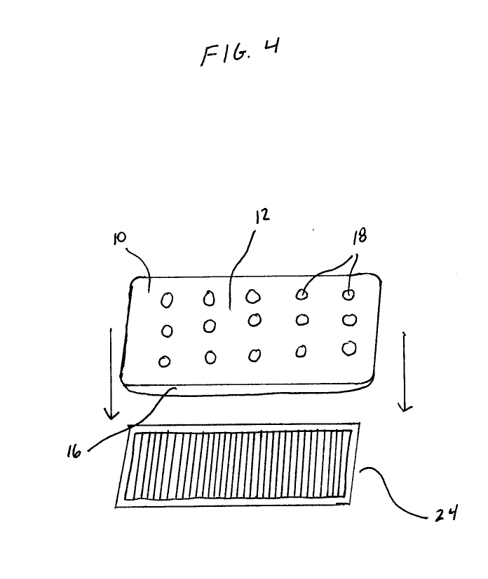

FIG. 4 shows the pet bed 10 being installed upon an air vent 24 for use. In one embodiment, the apertures 18 are formed in a region of the pet bed 10 that correspond to the area of an air vent 24.

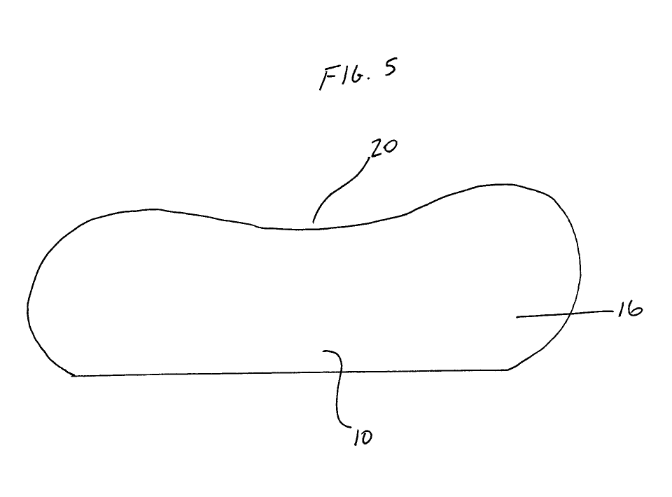

FIG. 5 shows the pet bed 10, its sidewall 16 and the central region depression 20 of the pet bed. The central region depression 20 promotes a pet nesting on the pet bed 10 and prevents a pet from falling off.

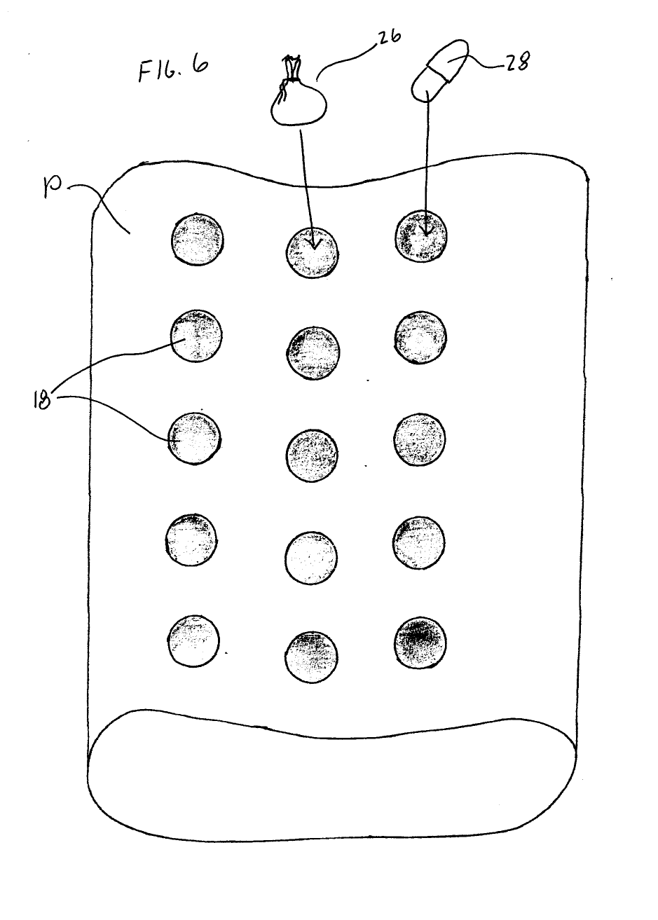

FIG. 6 shows the pet bed 10 with an attractant bag 26 and an attractant capsule 28 being installed into the apertures 18. The pet attractant in a preferred embodiment is Nepeta Cataria, but other substances that attract animals could be used. The attractant bag 26 can be made of cloth or other porous material that will allow the aroma of the pet attractant to be carried to the pet.

While a preferred embodiment of the invention has been described using specific terms, such description is for illustrative purposes only, and it is to be understood that changes and variations may be made without departing from the spirit or scope of the following claims.

I claim:

1. A pet bed comprising;
a top surface and a bottom surface where said top surface is substantially parallel to the bottom surface;
a sidewall;
a plurality of apertures formed through the pet bed in a direction that is perpendicular to said top surface and said bottom surface;
said plurality of apertures located in the pet bed so that they correspond to the area occupied by a floor air vent; and
an air-flow permeable removable porous cover.

2. The pet bed of claim 1, wherein the pet bed is made of foam.

3. The pet bed of claim 2, wherein the apertures have a diameter of 0.5-1.0 inch.

4. The pet bed of claim 3, wherein said top surface is formed to have a depression in its central region.

5. The pet bed of claim 4, further comprising a pet attractant inserted into one of more of said apertures.

6. The pet bed of claim 1, wherein the apertures have a diameter of 0.5-1.0 inch.

7. The pet bed of claim 6, wherein said top surface is formed to have a depression in its central region.

8. The pet bed of claim 7, further comprising a pet attractant inserted into one or more of said apertures.

9. The pet bed of claim 8, wherein the pet bed is made of viscoelastic polyurethane foam.

10. A method for creating a climate controlled environment for a pet, comprising the steps of:
Providing a pet bed with a top surface, a bottom surface and a sidewall where said top surface is substantially parallel to the bottom surface;
Forming a plurality of apertures through the pet bed in a direction that is perpendicular to said top surface and said bottom surface;
Locating said plurality of apertures in the pet bed so that they correspond to the area occupied by a floor air vent;
Installing a removable porous cover onto the pet bed;
Placing the pet bed on top of a floor air vent so that the apertures in the pet bed align with the area of the floor air vent;
Adjusting a thermostat to provide the desired temperature air; and
Introducing a pet to the bed for placement thereon.

11. The method of claim 10, further comprising the step of forming the bed of foam.

12. The method of claim 11, further comprising the step of forming apertures in the pet bed to have a diameter between the range of 0.5 and 1.0 inch.

13. The method of claim 12, further comprising the step of forming the top surface of the pet bed so that it has a depressed central region.

14. The method of claim 13, further comprising the step of inserting a pet attractant into one or more of said apertures.

15. The method of claim 10, further comprising the step of forming apertures in the pet bed to have a diameter between the range of 0.5 and 1.0 inch.

16. The method of claim 15, further comprising the step of forming the top surface of the pet bed so that it has a depressed central region.

17. The method of claim 16, further comprising the step of inserting a pet attractant into one or more of said apertures.

18. The method of claim 17, further comprising the step of forming the pet bed of viscoelastic polyurethane.
